(19) United States
(12) Patent Application Publication
(10) Pub. No.: US 2005/0061857 A1
(43) Pub. Date: Mar. 24, 2005

(54) Method for bonding a sputter target to a backing plate and the assembly thereof

(76) Inventors: Thomas J. Hunt, Peekskill, NY (US); Holger J. Koenigsmann, Congers, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 10/668,255

(22) Filed: Sep. 24, 2003

(51) Int. Cl. B23K 31/02

(52) U.S. Cl. 228/245; 228/256

(57) ABSTRACT

A method for solder bonding a sputter target to a backing plate having a plurality of spaced-apart ridges on its bonding surface to provide a uniform spacing and a uniform solder bonded interface; and the sputter target/backing plate assembly so produced.

### FIELD OF THE INVENTION

The invention relates to a method of bonding a sputter target to a backing plate, and more specifically, the use of a backing plate having spaced-apart ridges on the bonding surface of the backing plate so that the ridges provide a uniform spacing between the target and backing plate and a uniform solder bonded interface.

### BACKGROUND OF THE INVENTION

Cathodic sputtering is widely used for the deposition of thin layers of material onto desired substrates. Basically, this process requires a gas ion bombardment of a target having a face formed of a desired material that is to be deposited as a thin film or layer on a substrate. Ion bombardment of the target not only causes atoms or ions of the target material to be sputtered, but imparts considerable thermal energy to the target. This heat is dissipated beneath or around a backing plate that is positioned in a heat exchange relationship with the target. The target forms a part of a cathode assembly that, together with an anode, is placed in an evacuated chamber filled with an inert gas, preferably argon. A high voltage electrical field is applied across the cathode and the anode. The inert gas is ionized by collision with electrons ejected from the cathode. Positively charged gas ions are attracted to the cathode and, upon impingement with the target surface, these ions dislodge the target material. The dislodged target material traverses the evacuated enclosure and deposits as a thin film on the desired substrate, which is normally located close to the anode.

In addition to the use of an electrical field, increasing sputtering rates have been achieved by the concurrent use of an arch-shaped magnetic field that is superimposed over the electrical field and formed in a closed loop configuration over the surface of the target. These methods are known as magnetron sputtering methods. The arch-shaped magnetic field traps electrons in an annular region adjacent to the target surface, thereby increasing the number of electron-gas atoms collisions in the area to produce an increase in the number of positive gas ions in the regions that strike the target to dislodge the target material. Accordingly, the target material becomes eroded in a generally annular section of the target face, known as the target raceway.

In a conventional target cathode assembly, the target is attached at a single bonding surface to a nonmagnetic backing plate to form a parallel interface in the assembly. The backing plate is used to provide a means for holding the target assembly in the sputtering chamber and to provide structural stability to the target assembly. Also, the backing plate is normally water-cooled to carry away the heat generated by the ion bombardment of the target. Magnets are typically arranged beneath the backing plate in well-defined positions to form the above-noted magnetic field in the form of a loop or tunnel extending around the exposed face of the target.

To achieve good thermal and electrical contact between the target and the backing plate, these members are commonly attached to each other by use of soldering, brazing, diffusion bonding, mechanical fastening or epoxy bonding.

Smooth surface diffusion bonding is an applicable method of bonding, but has only limited use in the bonding of sputtering target components. The bond is produced by pressing the material surfaces into intimate contact while applying heat, to induce metallurgical joining and diffusion to a varying extent across the bond interface. Bonding aids, metal combinations which are more readily joined, are sometimes applied to one or both of the surfaces to be bonded. Such coatings may be applied by electroplating, electroless plating, sputtering, vapor deposition or other usable techniques for depositing an adherent metallic film. It is also possible to incorporate a metallic foil between bonding members that has the ability to be more easily bonded to either of the materials to be joined. The surfaces to be joined are prepared by chemical or other means to remove oxides or their chemical films which interfere with bonding.

Smooth surface diffusion bonding requires extreme care in preparation and in maintaining surface cleanliness prior to and during the bonding operation to ensure reliable bond qualities. Because the diffusion bond interfaces are planar, they are subject to stressing in simple shear which commonly leads to peeling away at the ends of the bond area. The formation of brittle intermetallics at the bond interface, which increase in thickness with the associated long times of heat exposure, add to the potential of bond shear failure. An additional technique for bonding, as described in U.S. Pat. No. 5,230,459 includes the pre-bonding step of providing machined grooves in the surface of one of the components to be solid-state bonded. This feature causes disruption of the bond surface of the associated component during heated pressure application. The material having the greater hardness will normally be provided with the grooves such that, during bonding, it will penetrate into the softer member with the softer metal substantially filling the grooves.

Groove bonding is applicable to bonding many dissimilar materials, but is limited to materials that have dissimilar melting temperatures because the process must occur near the melting temperature of the lower melting point alloy. This precludes the use of this technique for similar metals. It is also possible that the saw tooth nature of the grooves may act as a stress concentrator and promote premature cracking in the alloys near the bonds. Furthermore, machining of the grooves is a time consuming operation.

In U.S. Pat. No. 5,836,506, hereby incorporated by reference in its entirety, a method is disclosed for performing a surface roughening treatment to the bonding surface of the sputter target and/or backing plate, followed by solid state bonding. This. roughening surface treatment provides 100% surface bonding compared to only 99% surface bonding in the absence of the surface treatment. The treatment further provides a bond with over twice the tensile strength of a bond formed from the non-treated smooth surfaces.

In all of the above diffusion bonding processes, elevated temperatures of varying degree are applied to form the bond between the target and the backing plate. Thus, in each of these processes, changes in the microstructures of the target and backing plate materials are likely to occur because prolonged exposure of metals to elevated temperatures causes grain growth. Great strides have been made in this art to process sputter target blanks to achieve certain microstructures that are linked to increased sputtering efficiency and improved thin film quality. After a desired microstructure is obtained in the sputter target, it is in jeopardy of being altered by elevated temperature bonding methods for attaching the target to the backing plate.

Additionally, although diffusion bonding has been proven successful, extra large target/backing plate assemblies require large scale diffusion bonding presses and this poses a significant capital expenditure.

Prior art attempts to solve the problem of altering the microstructure of the sputter target using solder bonding. Maintaining a consistent and uniform solder bond requires the placing of wire gauges between the sputter target and backing plate. This method is labor intensive, costly and the wire spacer gauges tend to move during the bonding process. Additionally, when the wire gauges are used on the outer edges of the sputter target assembly, bowing of thin or large targets can occur due to an inconsistent thickness of sputter target material. Thickness uniformity of sputter targets is particularly important for ferromagnetic materials in order to achieve good thickness and sheet resistance uniformity of sputtered films.

It is an object of the invention to provide a method of forming a solder bonded sputter target/backing plate assembly that has a uniform thickness bond interface and uniform flatness of the target sputtering surface.

Another object of the invention is to provide a solder bonded sputter target/backing plate assembly that does not compromise the microstructural characteristics of the sputter target.

Another object of the invention is to provide a solder bonded sputter target/backing plate assembly having a plurality of spaced-apart ridges disposed on the bonding surface of the backing plate.

### SUMMARY OF THE INVENTION

There is provided a method for forming a solder bonded sputter target/backing plate assembly comprising the steps of:
a) forming a backing plate with a bonding surface having a plurality of spaced-apart ridges that are disposed on and within the periphery of the bonding surface of the backing plate;
b) forming a sputter target having a sputter surface and bonding surface;
c) applying a solder material to the interface spacing defined by superimposing said sputter target within the periphery of and onto the plurality of ridges on the backing plate; and
d) allowing said solder material to solidify and bond the sputter target to the backing plate so that the plurality of ridges provide an effective uniform thickness bonded interface.

### DESCRIPTION OF THE PREFERRED EMBODIMENT

In the preferred embodiment of the invention, the solder bonded sputter target/backing plate assembly would be disc-shaped and have a plurality of segmented arcuate-shaped ridges spaced apart on different radii of the bonded surface of the disc-shaped backing plate. An alternate embodiment of the invention is to apply a plurality of segmented arcuate-shaped ridges spaced apart on different radii of the bonded surface of the disc-shaped sputter target backing plate. Preferably, the backing plate and ridges are made of the same material and the height of the ridges will be constant so that a uniform thickness solder bonded interface spacing can be achieved. For most applications, the height of the ridges could vary between about 0.005 inch and about 0.050 inch, preferably between about 0.010 inch and about 0.030 inch and most preferably about 0.020 inch. The spacing of the ridges has to be sufficient to prevent bowing of the sputter target at the center, especially for thinner and large diameter sputter targets. The width of the ridges cannot be too wide since the bonding interface would be compromised or reduced by the surface area of the ridges. Thus the thickness of the width of the ridges could vary, depending on the application, between about 0.005 inch and about 0.050 inch, preferably between about 0.010 inch and about 0.030 inch and most preferably about 0.020 inch. The radial distance between adjacent arcuate shaped ridges can be between about 0.2 inch and about 2.0 inch, preferable about 1.0 inch. Preferably, the ratio of the area of the top surface of the ridges to the area of the bonded surface of the target should be no more than 10 percent, preferably not more than 4 percent.

The metals used for the sputter target and backing plate may be any of a number of different metals, either in pure or alloy form. For example, the sputter target may be made of titanium, aluminum, copper, molybdenum, cobalt, chromium, ruthenium, rhodium, palladium, silver, iridium, platinum, gold, tungsten, silicon, tantalum, vanadium, nickel, iron, manganese, germanium, or alloys thereof. The backing plate could be made of copper, aluminum, titanium, or alloys thereof. Preferred sputter target/backing plate metal pairings include a titanium target bonded to an aluminum backing plate; a titanium target bonded to a copper backing plate; a titanium target bonded to a titanium backing plate; a molybdenum target bonded to a copper backing plate; a cobalt target bonded to a copper backing plate; a chromium target bonded to copper backing plate; and a target formed of a precious metal such as ruthenium, rhodium, palladium, silver, iridium, platinum or gold, bonded to a copper backing plate. If a titanium-tungsten alloy is used, the alloy preferably includes about 10% to 15% titanium by weight.

Although the method has been described in conjunction with a disc-shaped sputter target/backing plate assembly, it will be readily apparent to one of ordinary skill that the method may be used to bond sputter targets and backing plates having any of a number of different shapes and sizes.

Depending on the shape of the sputter target/backing plate assembly, the shape of the ridges could be arcuate, circle, square, rectangular, polygon and a combination thereof. Preferably, the ridges should form a maze so that a liquid solder could flow between the ridges to provide a good interface bond for the sputter target/backing plate assembly.

Suitable solder materials would be liquid or paste solders having a melting temperature of generally less than 400° C., preferably less than 230° C. Examples of suitable solder materials are tin-lead, indium-tin, tin-silver, tin-copper, or tin-silver-copper.

### BRIEF DESCRIPTION OF THE DRAWINGS

FIG. 1 is a top and sectional view of a solder bonded sputter target/backing plate assembly using a ridged projected backing plate.

FIG. 2 is an enlarged cross-sectional view take at section A-A of the solder bonded sputter target/backing plate assembly of FIG. 1.

### DETAILED DESCRIPTION OF THE DRAWINGS

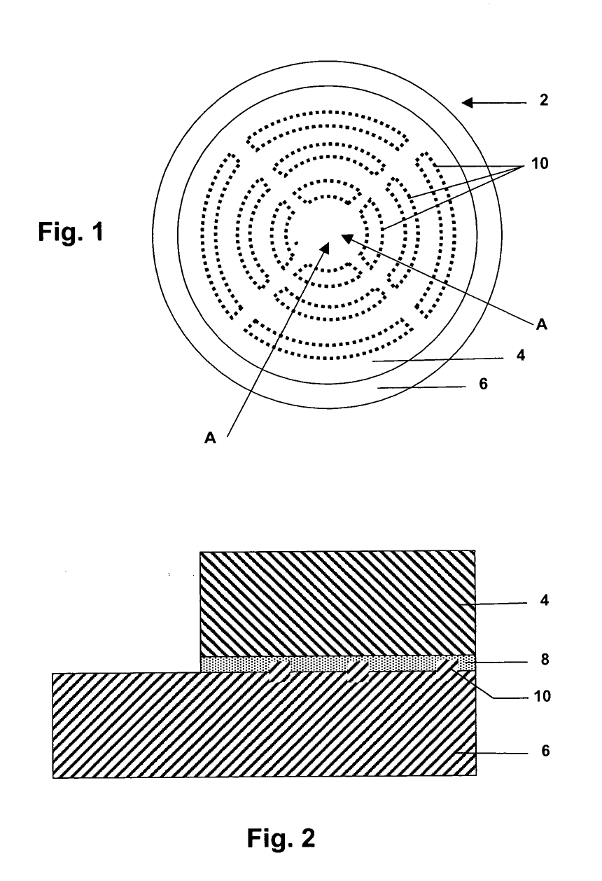

Referring to FIGS. 1 and 2 a solder bonded sputter target/backing plate assembly 2 is shown having a sputter target 4, backing plate 6 and an interface bonded solder 8. The backing plate 6 is made with a plurality of arcuate shaped ridges 10 equally spaced-apart radially to provide a uniform spacing between the sputter target 4 and the backing plate 6. The arrangement of the ridges as shown in FIG. 2 provides a maze type order to allow the solder material to be distributed at the interface of the sputter target 4 and backing plate 6.

The method of this invention is especially useful for solder bonding ferromagnetic sputter targets for 300 mm wafers as the nature of the material requires the thinner target configuration, with a greater sputter diameter, and it is therefore increasingly difficult to obtain a uniform bond layer thickness.

Advantages of this invention are consistent solder bond layer thickness, reduction in preparation time, uniform flatness of the target bonded, the ability to provide larger sputter target diameters with a uniform thickness bond interface, the ability to provide larger sputter target diameters with a uniform sputter target thickness, and reduction of time required for bonding, resulting in lower cost.

While the present invention has been illustrated by the description of an embodiment thereof, and while the embodiment has been described in considerable detail, it is not intended to restrict or in any way limit the scope of the appended claims to such detail. Additional advantages and modifications will readily appear to those skilled in the art. The invention in its broader aspects is therefore not limited to the specific details, representative assembly and method shown and described. Accordingly, departures may be made from such details without departing from the scope or spirit of applicants' general inventive concept.

1. A method for forming a solder bonded sputter target/backing plate assembly comprising the steps of:
a) forming a backing plate with a bonding surface having a plurality of spaced-apart ridges that are disposed on and within the periphery of the bonding surface of the backing plate;
b) forming a sputter target having a sputtering surface and bonding surface;
c) applying a solder material to the interface spaces defined by superimposing said sputter target within the periphery of and onto the plurality of ridges on the backing plate; and
d) allowing said solder material to solidify and bond the sputter target to the backing plate so that the plurality of ridges provide an effective uniform thickness solder bonded interface.

2. The method of claim 1 wherein the backing plate and sputter target are disc-shaped.

3. The method of claim 1 wherein the ridges on the bonding surface of the backing plate have a shape selected from the group comprising a circle, arcuate, square, rectangular, polygon and combination thereof.

4. The method of claim 1 wherein the height of the ridges is between about 0.005 inch and about 0.050 inch.

5. The method of claim 1 where the thickness of the width of the ridges is between about 0.005 inch and about 0.050 inch.

6. The method of claim 3 wherein the ridges are arcuate-shaped.

7. The method of claim 6 wherein the height of the ridges is between about 0.010 inch and about 0.030 inch and the thickness of the width of the ridges is between about 0.010 inch and about 0.030 inch.

8. The method of claim 7 wherein the height of the ridges is about 0.020 inch.

9. The method of claim 8 wherein the thickness of the width of the ridges is about 0.020 inch.

10. The method of claim 6 wherein the radial distance between the adjacent arcuate ridges is between about 0.2 inch and 2.0 inch.

11. The method of claim 10 wherein the height of the ridges is between about 0.010 inch and about 0.030 inch and the thickness of the width of the ridges is between about 0.010 inch and about 0.030 inch.

12. The method of claim 1 wherein the sputter target is selected from the group comprising titanium, aluminum, copper, molybdenum, cobalt, chromium, ruthenium, rhodium, palladium, silver, iridium, platinum, gold, tungsten, silicon, tantalum, vanadium, nickel, iron, manganese, germanium, and alloys thereof.

13. The method of claim 1 wherein the backing plate is selected from the group comprising copper, aluminum, titanium, and alloys thereof.

14. The method of claim 1 wherein the solder is liquid or paste and selected from the group comprising tin-lead, indium-tin, tin-silver, tin-copper, or tin-silver-copper.

15. The method of claim 14 wherein the sputter target is selected from the group comprising titanium, aluminum, copper, molybdenum, cobalt, chromium, ruthenium, rhodium, palladium, silver, iridium, platinum, gold, tungsten, silicon, tantalum, vanadium, nickel, iron, manganese, germanium, and alloys thereof.

16. The method of claim 15 wherein the sputter target is selected from the group comprising cobalt, nickel, and alloys thereof.

17. The method of claim 16 wherein the height of the ridges is between about 0.010 inch and about 0.030 inch and the thickness of the width of the ridges is between about 0.010 inch and about 0.030 inch.

18. A solder bonded sputter target/backing plate assembly comprising a backing plate having a plurality of spaced-apart ridges disposed on and within the periphery of the bonding surface of said backing plate; a sputter target having a sputter surface and a bond surface; said sputter target superimposed onto the plurality of ridges on the bonding surface of the backing plate; and a solder bonded layer disposed between the sputter target and backing plate and between the ridges producing an effective uniform thickness solder bonded interface for the sputter target/backing plate.

19. The solder bonded sputter target/backing plate assembly of claim 18 wherein the sputter target is selected from the group comprising titanium, aluminum, copper, molybdenum, cobalt, chromium, ruthenium, rhodium, palladium, silver, iridium, platinum, gold, tungsten, silicon, tantalum, vanadium, nickel, iron, manganese, germanium, and alloys thereof.

20. The solder bonded sputter target/backing plate assembly of claim 18 wherein the bonded solder is selected from the group comprising tin-lead, indium-tin, tin-silver, tin-copper, or tin-silver-copper.
